(19) United States
(12) Patent Application Publication
(10) Pub. No.: US 2007/0091196 A1
(43) Pub. Date: Apr. 26, 2007

(54) IMAGING APPARATUS

(75) Inventor: Makoto MIYANOHARA, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 11/552,658

(22) Filed: Oct. 25, 2006

(30) Foreign Application Priority Data
Oct. 26, 2005 (JP) 2005-310932

(51) Int. Cl. G02B 13/16

(52) U.S. Cl. 348/335

(57) ABSTRACT

An imaging apparatus including: an optical system which has a distortion in which a compression rate becomes larger along a direction from a center portion to an edge portion; an imaging device which converts an optical image received via the optical system to an electrical signal and outputs image data of a first angle of view; a feature extraction portion that extracts a feature of data which corresponds to a second angle of view among the image data, which includes an optical axis of the optical system and which is smaller than the first angle of view, and outputs as feature data; an object detection portion which outputs a signal which indicates whether or not the object is included in the second angle of view based on the feature data; an angle of view changing portion which selects and outputs the image data corresponding to the second angle of view when the signal input from the object detection portion indicates that the object is included, and which selects and outputs the image data corresponding to the first angle of view when the signal input from the object detection portion does not indicate that the object is included; a distortion correction portion which corrects a distortion in the image data output from the angle of view changing portion; and an image zoom-in/out portion which zooms in/out the image data output from the distortion correction portion in accordance with a desired image size.

### BACKGROUND OF THE INVENTION

1. Field of the Invention

The present invention relates to an imaging apparatus which is specially suitable for a digital camera, an endoscope system, a monitoring camera, a video camera, an imaging module of a cellular phone or the like.

Priority is claimed on Japanese Patent Application No. 2005-310932, filed Oct. 26, 2005, the content of which is incorporated herein by reference.

2. Description of Related Art

With respect to an imaging apparatus such as a digital camera or the like, a zooming function, which zooms based on the distance from an object and the size occupying an angle of view (a size of the object in the image) in accordance with user's requirements, is generally used. Such a zooming function is broadly divided into two types, one of them is an optical zoom which is realized by mechanically or automatically moving or sliding a lens set inside, and another is an electrical zoom which uses an image output from an imaging device and interpolates or thins out pixels. Generally, compared to the optical zoom, the electrical zoom can be realized cheaper and in a smaller size because it does not have a driving portion, however, the optical zoom has better image quality. Hence, an electrical zoom with higher image quality is desired.

In view of such circumstances, an input method for electrically zoomed images described in “Japanese Patent Application, First Publication No. H10-233950,” has been proposed. FIG. 29 shows an outline constitution of a system which realizes this input method of electrically zoomed images. In FIG. 29, this system includes an image compressing optical system 6L, a light receiving element 61, an image controlling portion 62, an image conversion portion 63, a memory portion and an output portion 65, and outputs an output image 66 based on a received light screen 6B after inputting an input screen 6A.

Hereinafter, operation of each constitution element shown in FIG. 29 is explained. The input screen 6A is input as the light receiving screen 6B on the received light element 61 via the image compressing optical system 6L which has the distortion characteristic of zooming in a center portion and optically compressing its edge portion. The image compressing optical system 6L is an optical system which generates a received light forming screen 5B as shown in FIG. 30. In FIG. 30, an object screen 5A corresponds to the input screen of FIG. 29. Screens 5AS, 5AM and 5AW of the object screen 5A indicate screens of a telephoto angle of view, an intermediate angle of view and a wide angle of view. The object image 5A is passed through the image compressing optical system 6L which optically compresses the edge portion of the image, and the received light forming screen 5B is formed on a receiving surface of the light receiving element 61. Screens 5BS, 5BM and 5BW of the object received light forming screen 5B are screens corresponding to screens 5AS, 5AM and 5AW, and the object received light forming screen 5B corresponds to the received light screen 6B in FIG. 29. Description of the compressed image optical system 6L is hereinabove.

Image data of the received light screen 6B input from the light receiving element 61 is converted to a digital image signal by the image control portion 62. An image conversion operation is operated on this digital image data by the image conversion portion 63, and, as a result, the received light screen 6B which has its edges optically compressed by the image compressing optical system 6L is reversely converted to the input image 6A. The digital image data on which the image conversion operation is conducted is converted to an image in accordance with a desired zooming ratio and is output to the output potion 65 as the output image 66.

The screen 5C in FIG. 30 corresponds to the output image 66 and the screens 5CS, 5CM and 5CW respectively correspond to the screens 5BS, 5BM and 5BW. In other words, the output portion 65, in accordance with desired zooming ratio, outputs one of the images among the screen 5CS, 5CM and 5CW. The memory portion 64 stores and maintains a digital image signal when it is needed.

FIG. 31 shows an example of an input image, which is input to the system of the above electrically zoomed image input method, and its group of output images. In FIG. 31, a screen M is an input screen on which the above electrically zoomed image input method is conducted. By applying an example of a zooming method of a quadruple wide angle screen, FIG. 31 shows ranges of zooming at an input screen obtained by a quadruple zooming specified by a symbol M1, a triple zooming specified by a symbol M2 and a double zooming specified by a symbol M3. In accordance with a desired zooming ratio, an input screen M is output as an output image CM, CM1, CM2 or CM3. In this case, the input screen M, zooming ranges M1, M2 and M3 respectively correspond to output images CM, CM1, CM2 and CM3.

In accordance with the input method of electrically zoomed images constituted in such a manner, even in a case in which the electrical zoom which has lower image quality than the optical zoom is conducted, when a center portion of the input screen is electrically zoomed, it is expected that a degradation of image quality caused by applying the electrical zoom can be decreased.

### SUMMARY OF THE INVENTION

A first aspect of the present invention is an imaging apparatus including: an optical system which has a distortion in which a compression rate becomes larger along a direction from a center portion to an edge portion; an imaging device which converts an optical image received via the optical system to an electrical signal and outputs image data of a first angle of view; a feature extraction portion that extracts a feature of data which corresponds to a second angle of view among the image data, which includes an optical axis of the optical system and which is smaller than the first angle of view, and outputs as feature data; an object detection portion which outputs a signal which indicates whether or not the object is included in the second angle of view based on the feature data; an angle of view changing portion which selects and outputs the image data corresponding to the second angle of view when the signal input from the object detection portion indicates that the object is included, and which selects and outputs the image data corresponding to the first angle of view when the signal input from the object detection portion does not indicate that the object is included; a distortion correction portion which corrects a distortion in the image data output from the angle of view changing portion; and an image zoom-in/out portion which zooms in/out the image data output from the distortion correction portion in accordance with a desired image size.

A second aspect of the present invention is an imaging apparatus including: an optical system which has a distortion characteristic in which a compression rate becomes larger along a direction from a center portion to an edge portion; an imaging device which converts an optical image received via the optical system to an electrical signal and outputs image data of a first angle of view; a feature extraction portion which extracts a feature of the image data and outputs as feature data; an object detection portion which outputs a signal which indicates whether or not the object is included in the image data based on the feature data; an object position calculation portion which calculates a position of the object in the image and generates position information when the signal input from the object detection portion indicates that the object is included; an angle of view determination portion which, based on the position information, determines a size of a second angle of view of the image data in a manner in which the second angle of view includes an optical axis of the optical system and is smaller than the first angle of view; an angle of view changing portion which selects and outputs the image data corresponding to the second angle of view when the signal input from the object detection portion indicates that the object is included, and which selects and outputs the image data corresponding to the first angle of view when the signal input from the object detection portion does not indicate that the object is included; a distortion correction portion which corrects a distortion in the image data output from the angle of view changing portion; and an image zoom-in/out portion which zooms in/out the image data output from the distortion correction portion in accordance with a desired image size.

A third aspect of the present invention is the above described imaging apparatus, wherein the feature extraction portion includes: an image data correction portion which corrects errors caused by the distortion characteristic of the optical system; and a feature calculation portion which calculates the feature data based on the image data corrected by the image data correction portion.

A fourth aspect of the present invention is the above described imaging apparatus, wherein the feature extraction portion includes: an image data storing portion which stores the image data of a prior image; and a motion vector detection portion which detects a motion vector based on both the image data stored in the image data storing portion and image data following the prior image data, and outputs the motion vector as feature data, wherein the object detection portion includes a vector analysis portion which, based on the motion vector, outputs a signal which indicates whether or not the object is included.

A fifth aspect of the present invention is the above described imaging apparatus, wherein the vector analysis portion outputs a signal which indicates that the object is included when an absolute value of the motion vector which is output from the motion vector detection portion is smaller than a predetermined threshold.

A sixth aspect of the present invention is the above described imaging apparatus, wherein: the feature extraction portion includes a brightness distribution generation portion which generates a brightness distribution based on the image data and outputs as the feature data; and the object detection portion includes a brightness distribution analysis portion which, based on the brightness distribution, outputs a signal which indicates whether or not the object is included.

A seventh aspect of the present invention is the above described imaging apparatus, wherein the feature extraction portion adjusts a center of the second angle of view in order to correspond with the optical axis of the optical system.

An eighth aspect of the present invention is the above described imaging apparatus, wherein the angle of view determination portion adjusts a center of the second angle of view in order to correspond with the optical axis of the optical system.

### BRIEF DESCRIPTION OF THE DRAWINGS

FIG. 1 is a conceptual figure which shows an image be captured in a first embodiment of the present invention.

FIG. 2 is a figure of an outline structure and which shows an outline structure of a digital camera of the first embodiment of the present invention.

FIG. 3 is a block diagram which shows the detailed structure of the digital camera of the first embodiment of the present invention.

FIG. 4 is a reference figure for explaining a characteristic of an optical system provided by the digital camera of the first embodiment of the present invention.

FIG. 5 is a reference figure showing an optical image for explaining the characteristic of the optical system provided by the digital camera of the first embodiment of the present invention.

FIG. 6 is a reference figure showing an optical image for explaining the characteristic of the optical system provided by the digital camera of the first embodiment of the present invention.

FIG. 7 is a reference figure showing an optical image for explaining the characteristic of the optical system provided by the digital camera of the first embodiment of the present invention.

FIG. 8 is a reference figure showing an arrangement of colored filters of an imaging device provided by the digital camera of the first embodiment of the present invention.

FIG. 9 is a block diagram which shows the structure of a feature extraction portion provided by the digital camera of the first embodiment of the present invention.

FIG. 10 is a timing diagram explaining operations of the feature extraction portion provided by the digital camera of the first embodiment of the present invention.

FIG. 11 is a reference figure for explaining an object determination area of the first embodiment of the present invention.

FIG. 12 is a reference figure for explaining the positional relationship between the center of an optical image and an imaging device of the first embodiment of the present invention.

FIG. 13 is a reference figure for explaining the positional relationship between the center of an optical image and an imaging device of the first embodiment of the present invention.

FIG. 14 is a reference figure for explaining the object determination area of the first embodiment of the present invention.

FIG. 15 is a reference figure for explaining the method of a motion vector detection of the first embodiment of the present invention.

FIG. 16 is a reference figure for explaining the method of a motion vector detection of the first embodiment of the present invention.

FIG. 17 is a reference figure for explaining the method of a motion vector detection of the first embodiment of the present invention.

FIG. 18 is a reference figure for explaining the method of a motion vector detection of the first embodiment of the present invention.

FIG. 19 is a block diagram which shows the structure of an object detection portion provided by the digital camera of the first embodiment of the present invention.

FIG. 20 is a reference figure which shows the operation of an object detection portion provided by the digital camera of the first embodiment of the present invention.

FIG. 21 is a reference figure which shows the operation of a distortion correction portion provided by the digital camera of the first embodiment of the present invention.

FIG. 22A is a reference figure which shows the operation of an angle of view changing portion and an image zooming-in/out portion provided in the digital camera of the first embodiment of the present invention.

FIG. 22B is a reference figure which shows the operation of an angle of view changing portion and an image zooming-in/out portion provided in the digital camera of the first embodiment of the present invention.

FIG. 22C is a reference figure which shows the operation of an angle of view changing portion and an image zooming-in/out portion provided in the digital camera of the first embodiment of the present invention.

FIG. 22D is a reference figure which shows the operation of an angle of view changing portion and an image zooming-in/out portion provided in the digital camera of the first embodiment of the present invention.

FIG. 23 is a conceptual figure which shows an image be captured in a second embodiment of the present invention.

FIG. 24 is a block diagram which shows detailed structure of an endoscope system of a second embodiment of the present invention.

FIG. 25 is a block diagram which shows the structure of a feature extraction portion provided in the endoscope system of the second embodiment of the present invention.

FIG. 26 is a conceptual figure which shows an image of brightness distribution in a second embodiment of the present invention.

FIG. 27 is a block diagram which shows the structure of an object detection portion provided in the endoscope system of the second embodiment of the present invention.

FIG. 28 is a conceptual figure which shows an image of brightness distribution in a second embodiment of the present invention.

FIG. 29 is a figure of an outline constitution and which shows an outline constitution of a system using a conventional electrically zoomed image input method.

FIG. 30 is a reference figure which shows changes of a screen in a conventional electrically zoomed image input method.

FIG. 31 is a reference figure which shows one example of an input screen and an output screen of a conventional electrically zoomed image input method.

### DETAILED DESCRIPTION OF THE INVENTION

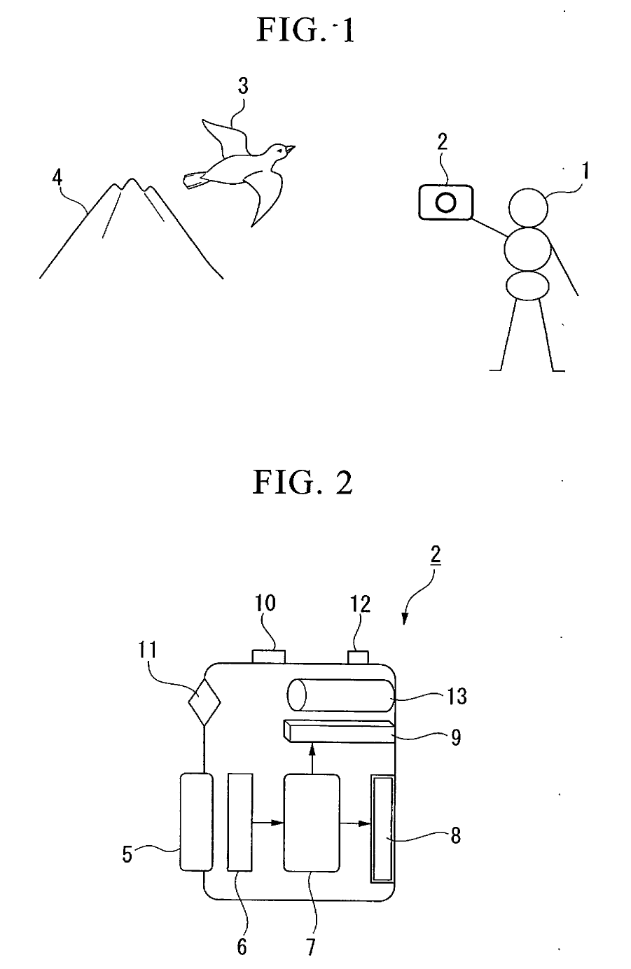

Hereinafter, referring to figures, embodiments of the present invention are explained. First, a first embodiment of the present invention is explained with respect to a digital camera provided with an imaging apparatus of the present invention as an example. FIG. 1 shows an image to be captured in which the digital camera is used. In FIG. 1, in order to take a photo of an object 3, a photographer 1 is taking a photo with the digital camera 2 in their hand. The photographer 1 operates the digital camera 2 when they want to take a photo, and a photo is taken of the object 3 together with a background 3.

FIG. 2 shows an outline constitution (both an external constitution and an internal functional constitution) of the digital camera 2 of this embodiment. In FIG. 2, a lens unit 5 adjusts a focal distance, an exposure and the like of an optical zoom, and forms an optical image via a lens. An image sensor 6 converts the optical image to electrical signals after two-dimensionally receiving light. A system LSI 7 conducts a desired operation on image data input from the image sensor 6.

A display portion 8, which is a display apparatus such as a liquid crystal display or the like, displays the optical image received by the image sensor 6 as an image or a picture based on the image data output from the system LSI 7. Media 9 is used for recording and storing the image after taking photo. A shutter button 10 is a button for inputting a command to take a photo. A flash 11 is a light source used as a flashing apparatus which flashes upon taking photo. A power source button 12 is a button for inputting a command to turn on/off the digital camera 2. A battery 13 supplies electrical power for driving to each of the portion above and drives the digital camera 2.

An outline of the operation of the digital camera 2 with the constitution above is explained. First, when the photographer pushes the power source button 12, electrical power is supplied to the each constitution element of the digital camera from the battery 13. The image sensor 6 receives an optical image via a lens of the lens unit 5, and continuously, the optical image received by the image sensor 6 is continuously displayed as an image on the display portion 8. The photographer who takes a photo with the digital camera 2, adjusts the focal distance, the exposure or the like of the lens unit 5 if desired when recognizing the image displayed on the display portion 8, and takes a photo by pushing the shutter button 10 when conditions of taking a photo are satisfied. When the shutter button 10 is pushed, the flash 11 flashes and the object is irradiated.

The image sensor 6 receives the light from the object via the lens of the lens unit 5, converts it to an electrical signal and outputs image data. An operation for obtaining higher image quality on the output image signal is conducted by the system LSI 7, and finally, the media 9 records/stores the data as the photographed image. The photographed image obtained in accordance with steps above is, for example, stored in a PC or the like and displayed on a monitor, or printed as a picture which is viewed or saved.

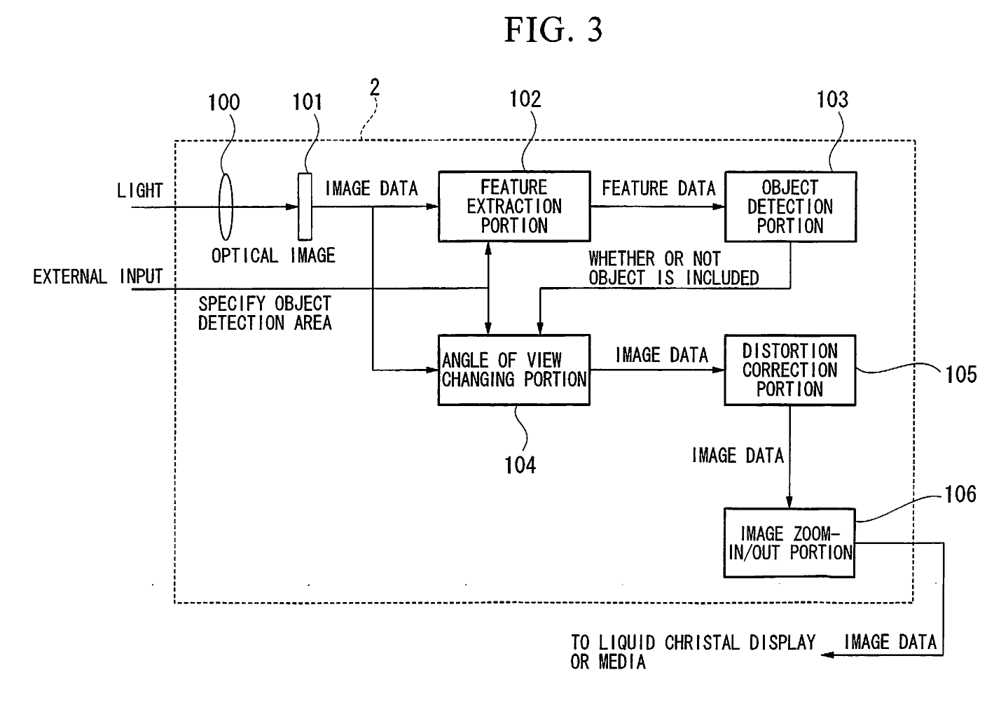

Details of the constitution of the digital camera 2 are explained. FIG. 3 shows the constitution of characteristic portions of the digital camera 2 of this embodiment. The digital camera 2 includes a lens 100, an imaging device 101, a feature extraction portion 102, an object detection portion 103, an angle of view changing portion 104, a distortion correction portion 105 and an image zooming-in/out portion 106. The lens 100 is included in the lens unit 5 shown in FIG. 2, and the imaging device 101 corresponds to the image sensor 6. The feature extraction portion 102, the object detection portion 103, the angle of view changing portion 104, the distortion correction portion 105 and the image zooming-in/out portion 106 are included in the system LSI 7.

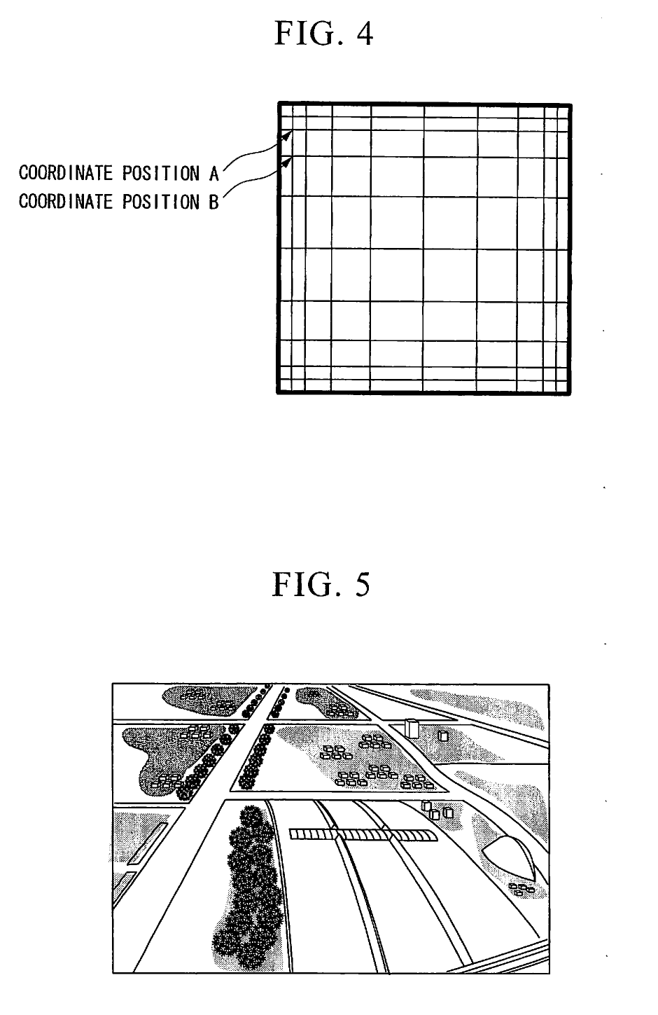

As shown in FIG. 4, lens 100 is an optical system which has a large distortion characteristic in which an optical compressing ratio of an image is larger along a direction from a center portion of the lens to an outside edge. In FIG. 4, the thick line on the outside edge indicates an input range of an image input to this optical system. Multiple narrow lines indicate how a distortion caused by passing through this optical system affects lines which are virtual lines vertically and horizontally set at a regular interval on the optical image before being input to this optical system. In other words, with respect to the input image, lens 100 is an optical system which optically zooms in a central portion of the optical image and compresses it by applying a horizontally and vertically independent compressing ratio which becomes higher along a direction from the central portion to the outside edge.

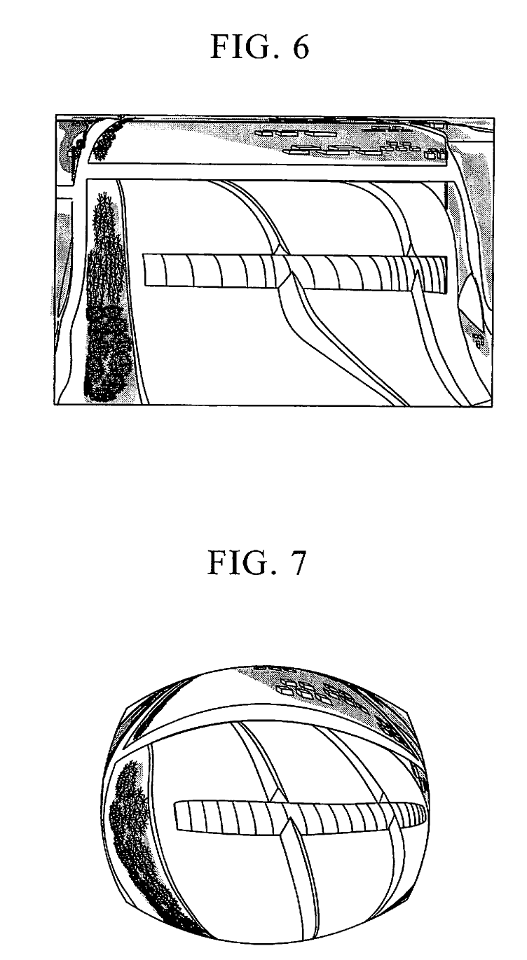

The original image shown in FIG. 5 is converted to the image shown in FIG. 6 which is an optical image obtained by passing through the lens 100. The optical system above, such as described in “Japanese Patent Application, First Publication No. H10-233950”, is realized by applying a constitution which includes: a cylindrical lens in which a horizontal compression rate becomes gradually larger in proportion to the distance from a center portion; and a cylindrical lens in which a vertical compression rate becomes gradually larger in proportion to the distance from a center portion, to a portion of the optical system. This embodiment explains a case of applying the above described optical system which compresses in accordance with a compression rate which becomes higher in vertical and horizontal directions independently. However, it is possible to apply an optical system which is called a coaxial system in which an optical image shown in FIG. 7 is formed by optically zooming in a center portion of the optical image with respect to the original image shown in FIG. 5 and compressing it with a compression rate which becomes coaxially higher in proportion to the distance from the center portion of the lens.

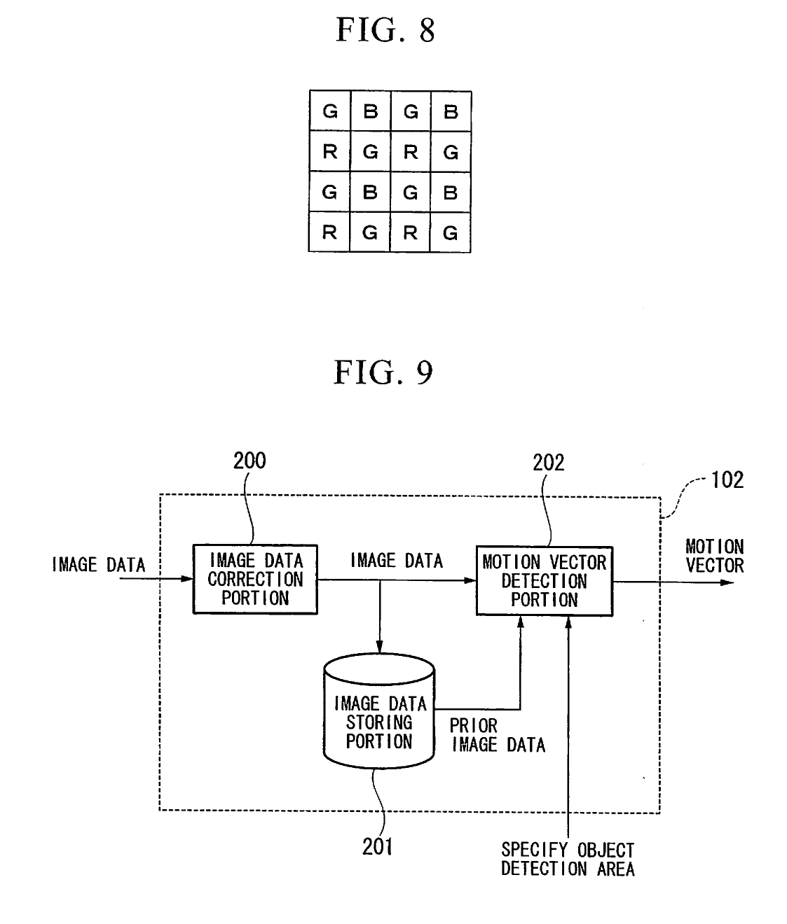

The imaging device 101, which two-dimensionally receives the optical image formed through the lens 100 and converts it to electrical signals, includes the constitution/mechanism which is necessary for generating image data such as: a color filter; a solid-state image sensing device such as a CCD (Charge Coupled Device), CMOS (Complementary Metal Oxide Semiconductor) sensor or the like; an A/D converter; and the like. The imaging device 101 has the color filter which transmits light of specific colors and which is adhered on a front surface, and has multiple light receiving elements on a two-dimensional plane as shown in FIG. 8 for converting the received light to the electrical signals.

FIG. 8 shows the color filters which transmit specific colors are provided (R is Red, G is Green, B is Blue) to the light receiving elements which are divided into multiple. Each time a photo is taken, an electrical signal generated from one light receiving element is dealt with as one pixel, and a group of the electrical signals generated by the light receiving elements is dealt with as one image. An image size such as CIF (Common Intermediate Format: horizontally 352×vertically 288), VGA (Video Graphics Array: horizontally 640×vertically 480) or the like depends on the number of the light receiving elements arranged on the two-dimensional plane. The generated electrical signals are converted to image data which is digital signals by the A/D converter. The image data obtained by converting to the digital signals is output after operations for improving image quality such as correcting pixel defects, interpolating a pixel among other pixels, and the like, if such operations are necessary.

The feature extraction portion 102, with respect to the image data output from the imaging device 101, extracts features inside a fixed area (object determination area) externally input/specified beforehand by the photographer before taking a photo. Hereinafter, in this embodiment, a method of determining whether or not the object is included in a fixed area by extracting a feature after detecting a motion vector and by analyzing the motion vector. The feature extraction portion 102, as shown in FIG. 9, includes an image data correction portion 200, an image data storing portion 201, and a motion vector detection portion 202. The image data storing portion 201 and the motion vector detection portion 202 constitute a feature calculation portion.

The image data correction portion 200 corrects influences on images, which are caused by using the lens 100 which has distortion, such as optically caused distortions, increased light caused by compressing edges, or the like. It is possible to extract feature data after removing influences of the distortion characteristics by the above means. Distortion of the lens 100 caused optically is corrected (correcting errors in the image data caused by distortion characteristics of the optical system) in order to accurately detect the motion vector by the motion vector detection portion 202. A method of correcting the distortion is described later. With respect to the image data correction portion 200, it is possible to apply various known methods for conducting correction such as distortion correction, shading correction, or the like.

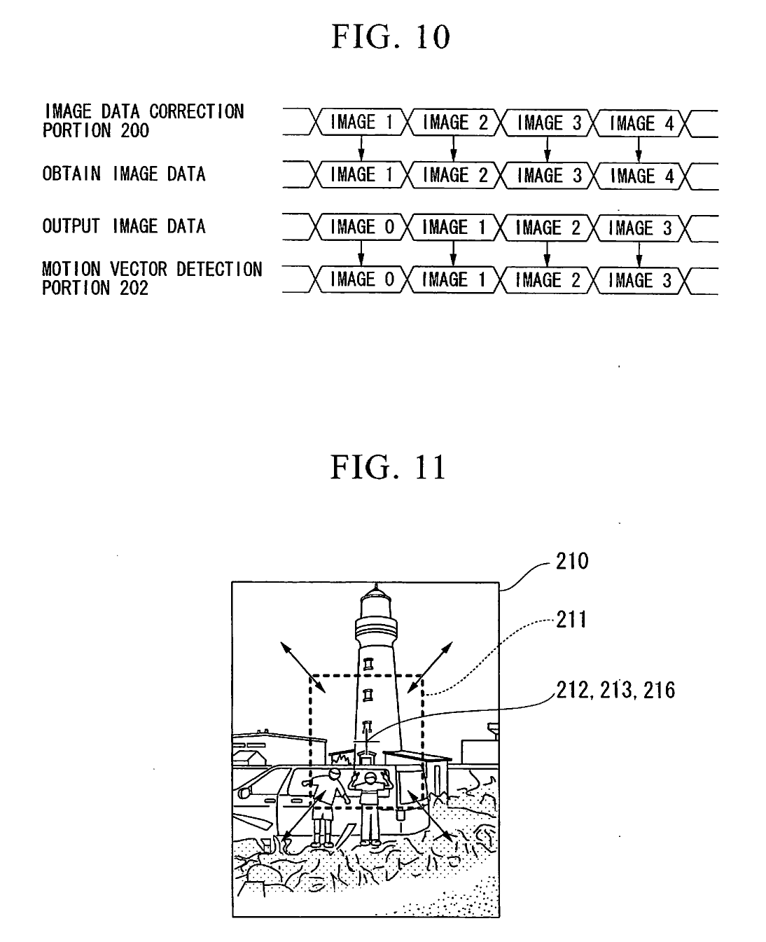

The image data storing portion 201 has a memory constituted from SRAM or the like, and stores one frame of the image data which is output from the image data correction portion 200. As shown in FIG. 10, in accordance with timings at which the image data storing portion 201 repeats both storing the image data which is output from the image data correction portion 200 and outputting the stored image data to the motion vector detection portion 202. There are definitions below in the timing chart shown in FIG. 10. An image N (N is an integer) shown in the timing chart is the image on which the operation is currently conducted. For example, in the timing of image 1 and in the image data correction portion 200 shown in the figure, the image data correction portion 200 corrects the image data of the image 1.

As shown in the timing chart of FIG. 10, when the image data correction portion 200 corrects the image 2, the image data storing portion 201 stores the image data of the image 2 which is output from the image data correction portion 200 along with outputting the image data of the image 1 which is stored in the memory to the motion vector detection portion 202.

The motion vector detection portion 202 detects the motion vector (feature data) of following image data which is output from the image data correction portion 200 by referring to prior image data (for example, the image data prior to the frame 1) which is output from the image data storing portion 201. The motion vector detection portion 202 is also included in the specified fixed area. The detected motion vector is, as described below, used by the object detection portion 103 for detecting whether or not there is an object.

Hereinafter, the object detection area of this embodiment is explained. FIG. 11 shows a case in which a fixed area is specified as the object detection area on the image which is output from the image data correction portion 200. In FIG. 11, an image 210 is an image which is output from the image data correction portion 200, and an object detection area 211 is a specified area for detecting the motion vector. A center 212 is the center of the object detection area 211. The object detection area 211 is variable and is specified beforehand by the photographer via an UI (User Interface). In this example, the center 212 of the object detection area 211 is the same position as a center 213 of the optical image formed by the lens 100 (that is, a position of the optical axis of the optical system).

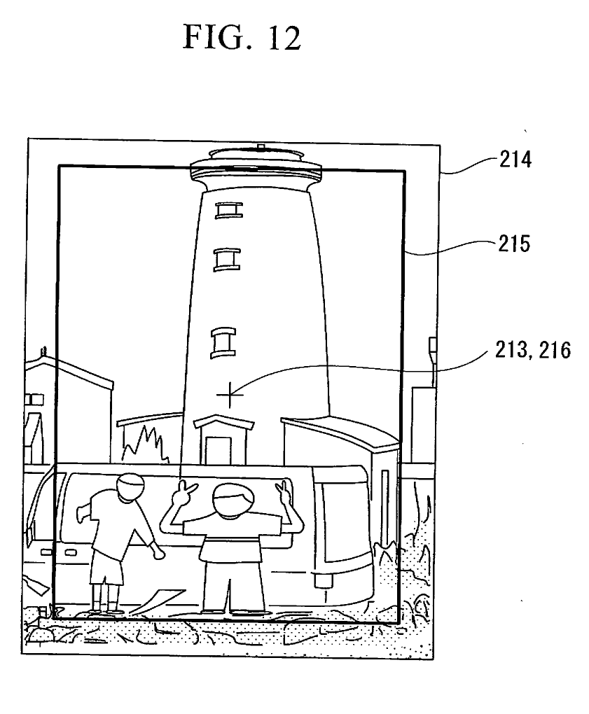

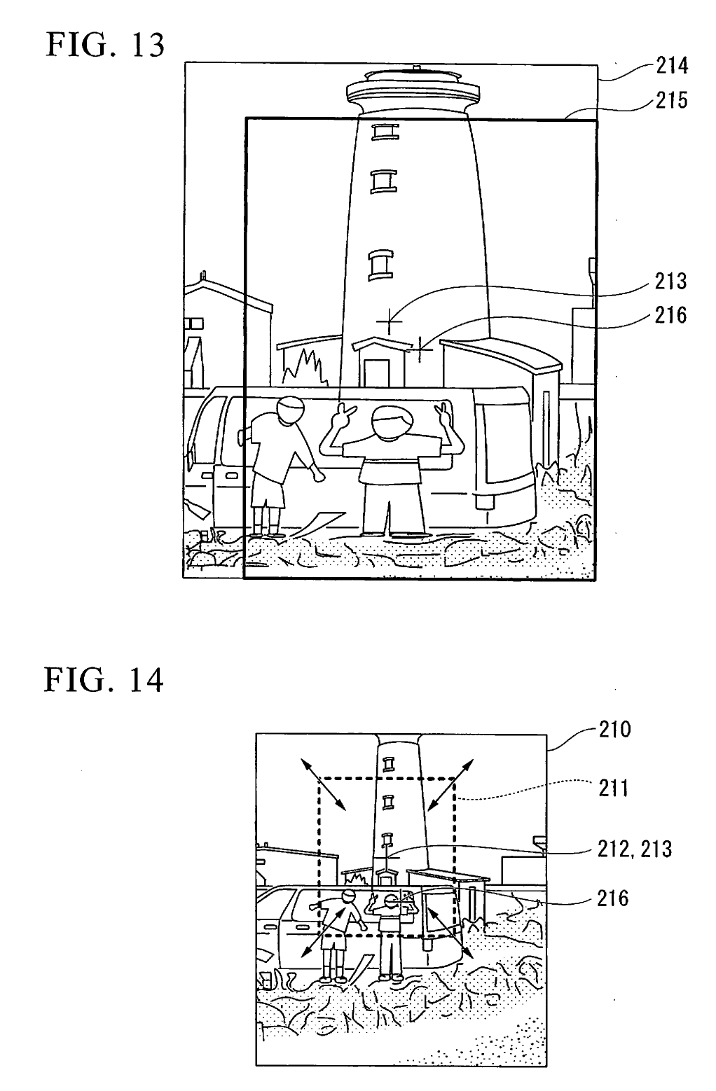

As shown in FIG. 12, if an optical image 214 formed by the lens 100 is irradiated on a center of a light receiving area 215 of the imaging device 101, the center 213 of the optical image and a center of the imaging device 101 are at a same position, and also the center 212 of the object detection area 211 of FIG. 11 and the center 216 of the imaging device 101 are at a same position. On the other hand, as shown in FIG. 13, if an optical image 214 formed by the lens 100 is irradiated on a position which has a gap from the center of the light receiving area 215 of the imaging device 101, there is a gap between the center 213 of the optical image and the center of the imaging device 101. As shown in FIG. 14, the object detection area 211 is specified in a state in which there is a gap between the center 212 of the object detection area 211 and the center 216 of the imaging device 101.

In all embodiments including this embodiment, for convenience of explanation, it can be assumed that the center of the optical image formed by the lens 100 corresponds to the center of the imaging device 101, however, it is possible to explain even when there is a gap between the center of the optical image and the center of the imaging device 101.

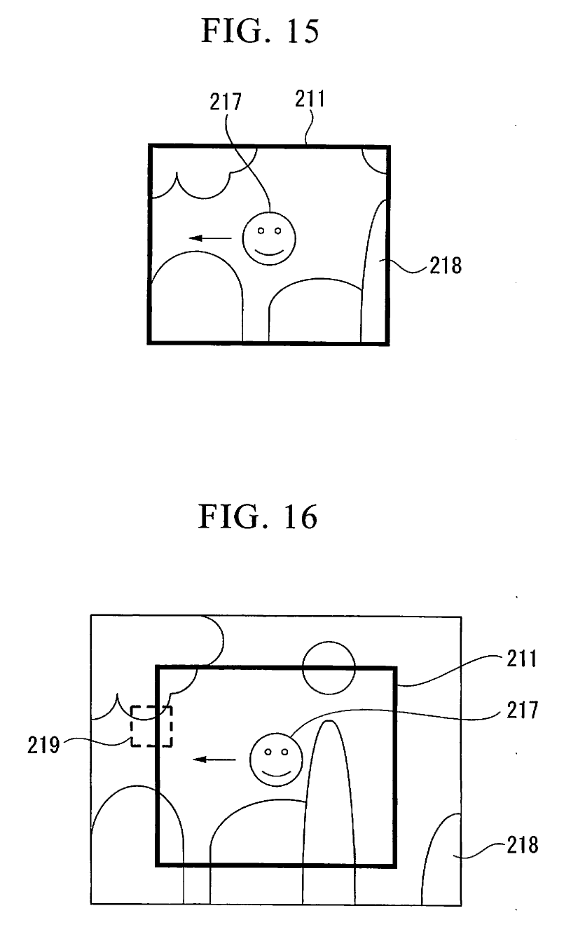

Hereinafter, a method of detecting the motion vector in accordance with a well-known block matching method is explained, and in this method, both an image of the object detection area shown in FIG. 15 and an image output from the image data storing portion 201 shown in FIG. 16 are used. As shown in FIG. 15, in the object detection area 211 including an object 217 and a background 217, the object 217 which is about to be photographed by the photographer is moving in a direction of the arrow.

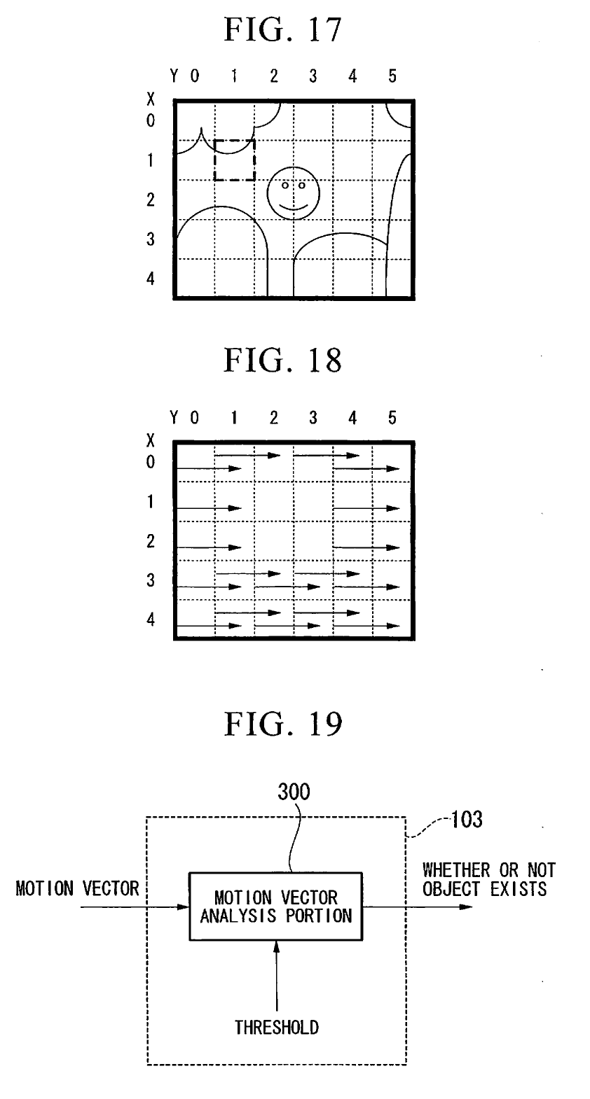

In the block matching method, first blocks are formed by dividing areas in accordance with broken lines shown in FIG. 17 with respect to the image of the object detection area 211 of FIG. 15. For convenience of explanation, the upper-left most block is shown as a block (0, 0). Based on this block, a number is vertically assigned as X and a number is horizontally assigned as Y (X and Y are integers), and the blocks are defined as block (X, Y).

With respect to each of the blocks which are divided into areas and in accordance with the pattern matching, a calculation is conducted in order to determine which part of the prior image shown in FIG. 16 corresponds to the block. For example, block (1, 1) in FIG. 17 is determined to be the same as a matching area 219 specified with a broken line in FIG. 16 by comparing the image data to the image data of FIG. 16. In other words, block (1, 1) in FIG. 17 was inside the matching area 219 in the prior image, and the motion vector of block (1, 1) in FIG. 17 is expressed as a vector based on a positional relationship between block (1, 1) in the object detection area 211 and the matching area 219.

FIG. 18 shows the motion vectors obtained in a case in which the above operation is operated on each block of FIG. 17. The motion vector detection portion 202 outputs the motion vector shown in FIG. 18 as the feature data output from the feature extraction portion 102.

In FIG. 3, the object detection portion 103 detects whether or not the object is included in the object detection area by analyzing the feature data output from the feature extraction portion 102 and outputs a signal which indicates whether or not the object is included in the image data. As shown in FIG. 19, the object detection portion 103 has a motion vector analysis portion 300. In order to detect whether or not the object exists by analyzing the motion vector, the motion vector analysis portion 300 calculates an absolute value of the motion vector which is output from the motion vector detection portion 202.

When a coordinate in the prior image is expressed by (A2, B2) and the coordinate in the image of the object detection area is expressed by (A1, B1), the absolute value of the motion vector which is a vector showing a motion from the coordinate (A1, B1) to the coordinate (A2, B2) is calculated in accordance with the formula (1) shown below.
An absolute value Z of the motion vector=|√((A1−A2)²+(B1−B2)²)| (1)

FIG. 18 shows the motion vectors. There is no motion vector at the blocks (1, 2), (1, 3), (2, 2) and (2, 3), therefore, the absolute values of the motion vectors corresponding to these blocks are approximately 0. This shows that, with respect to the moving object 217 shown in FIG. 15, the range in which the digital camera 2 can photograph moves along with the movement of the object 217. Hence, with respect to the motion vector shown in FIG. 18, it is possible to detect that the object exists inside the object detection area 217.

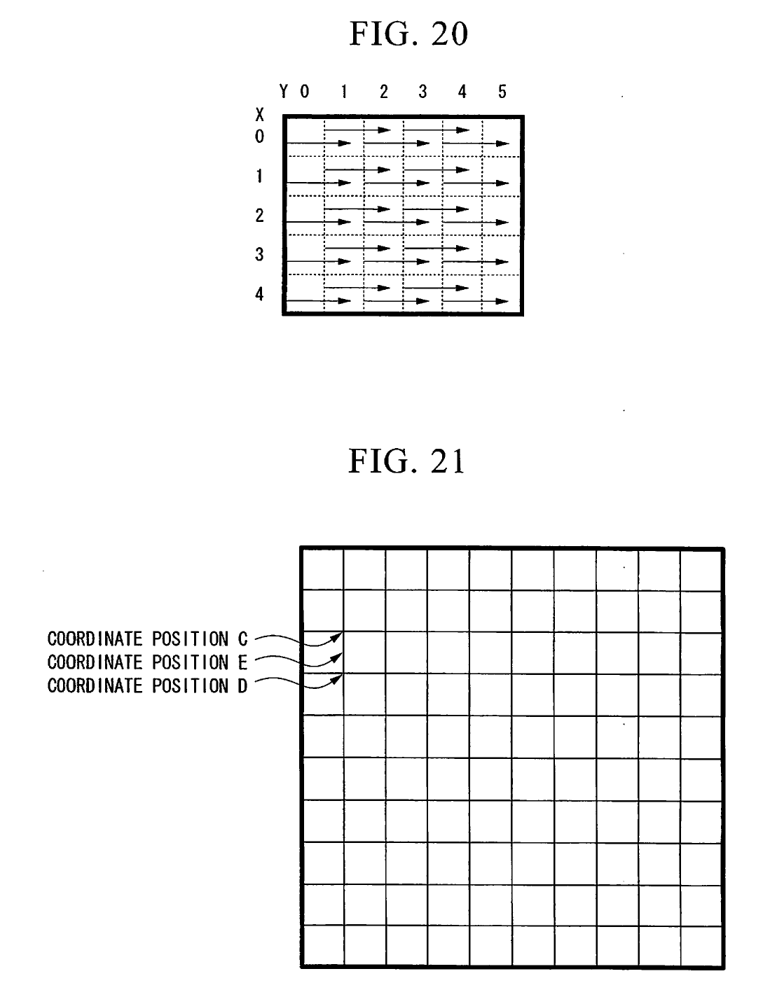

On the other hand, as shown in FIG. 20, when the motion vectors corresponding to all the blocks are the same, it can be assumed that the photographer is moving the digital camera 2 in order to find the object, therefore, it is possible to determine that the object is not included in the object detection area 217. When the determination above is made, the motion vector analysis portion 300 determines whether or not the object exists by comparing the absolute value of the motion vector and a threshold which is predetermined based on the photographer's request, conditions or the like.

In other words, when all the absolute values of the motion vectors are greater than or equal to the predetermined threshold, the motion vector analysis portion 300 outputs a signal which indicates that the object does not exist inside the object detection area. When there is an absolute value of the motion vectors which is smaller than the predetermined threshold, the motion vector analysis portion 300 outputs a signal which indicates that the object is included in the object detection area. Therefore, it is possible to detect whether or not the object exists upon photographing the object along with following the motion of the object.

Upon photographing with a digital camera, it is assumed that there are various objects and, with respect to each of them, it is assumed that there is a best condition for detection, therefore, the conditions for detecting whether or not the object exists are not limited by the conditions described above and it is possible to apply other methods or conditions than the method described above.

In FIG. 3, the angle of view changing portion 104 determines image data to be output based on the object detection result of the object detection portion 103. In a case in which the object detection portion 103 detects that the object is included in the object detection area, the angle of view changing portion 104 outputs the image data included in the object detection area, and in a case in which the object detection portion 103 does not detect that the object is included in the object detection area, the angle of view changing portion 104 outputs the image data which is output from the imaging device 101. In effect, the angle of view which is an area for photographing is determined with respect to the image obtained from the imaging device, and this is the reason why the reference numeral 104 is named the angle of view changing portion.

In other words, when the angle of view based on the image data output from the imaging device 101 is defined as a first angle of view and the object detection area is defined as a second angle of view which is smaller than the first angle of view, the angle of view changing portion 104 selects and outputs the image data corresponding to the second angle of view if the input signal from the object detection portion 103 indicates that the object is included in the object detection area. The angle of view changing portion 104 selects and outputs the image data corresponding to the first angle of view if the input signal from the object detection portion 103 does not indicate that the object is included in the object detection area. Based on the motion vector, it is detected whether or not the object is included in the object detection area; therefore, it is possible to apply the angle of view in accordance with the motion vector of the object.

With respect to the image data output from the angle of view changing portion 104, the distortion correction portion 105 corrects the distortion which is optically caused by the lens 100. The image data input from the distortion correction portion 105 is corrected from the image data which has distortion as shown in FIG. 4 to the image data which does not have the distortion as shown in FIG. 21.

Hereinafter, an example of a distortion correction method is explained. First, based on the compression ratio which is applied to an optical compression by the lens 100, with respect to the image data at each coordinate position included in the image which has the distortion, the coordinate position after distortion correction is determined and the image data is converted to the coordinate position. The image which has distortion is optically compressed; therefore, with respect to the image after distortion correction, a lack of image data is caused by only converting each image data of the image which has distortion to the coordinate position which is determined by distortion correction.

After distortion correction, with respect to the image data of each coordinate position, the image data at the coordinate positions to which nothing is converted is interpolated based on the image data of the coordinate positions to which the conversion is operated. For example, the image data of the coordinate positions A and B of FIG. 4 is converted to the image data at the coordinate positions C and D of FIG. 21. The image data at the coordinate position E which is not supplied is generated by interpolating based on the image data at the coordinate positions C and D referring to the positional relationship to the coordinate position E. The distortion correction method of the distortion correction portion 105 is not limited to the above described method, and it is possible to apply various well-known distortion correction methods.

The image zoom-in/out portion 106 zooms in/out the image data output from the distortion correction portion 105 in accordance with the image size required from an external apparatus to which the digital camera 2 outputs. For example, when the digital camera 2 outputs to a display apparatus such as the display portion 8 shown in FIG. 2, the image size shown on the display portion 8 is fixed. On the other hand, the image data output from the angle of view changing portion 104 is determined in accordance with whether or not the object is included in the object detection area; therefore, the image size is changed as well.

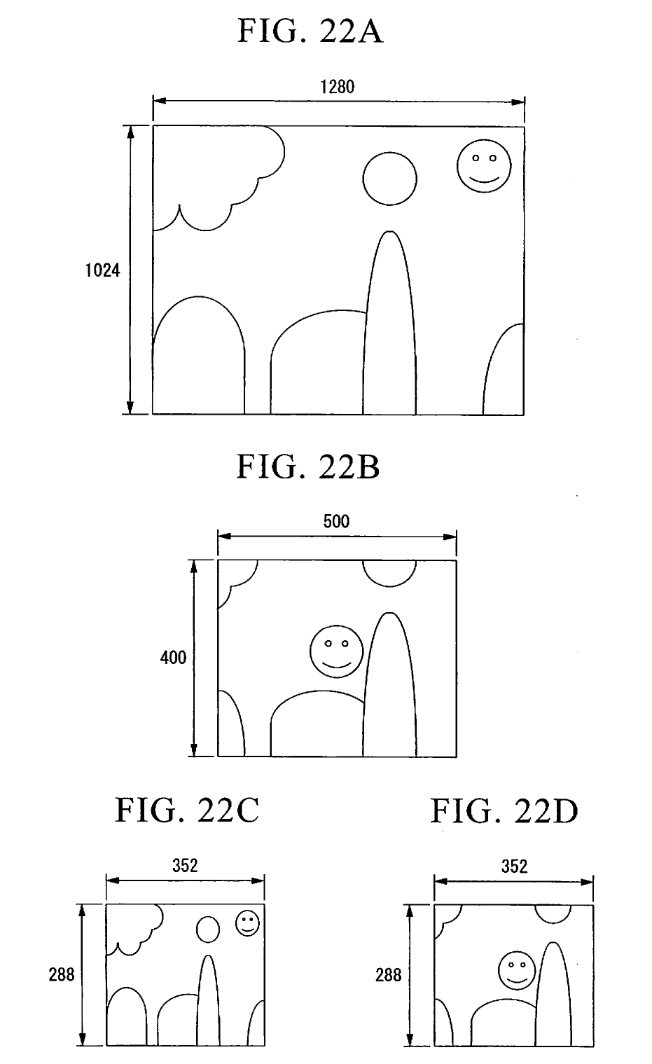

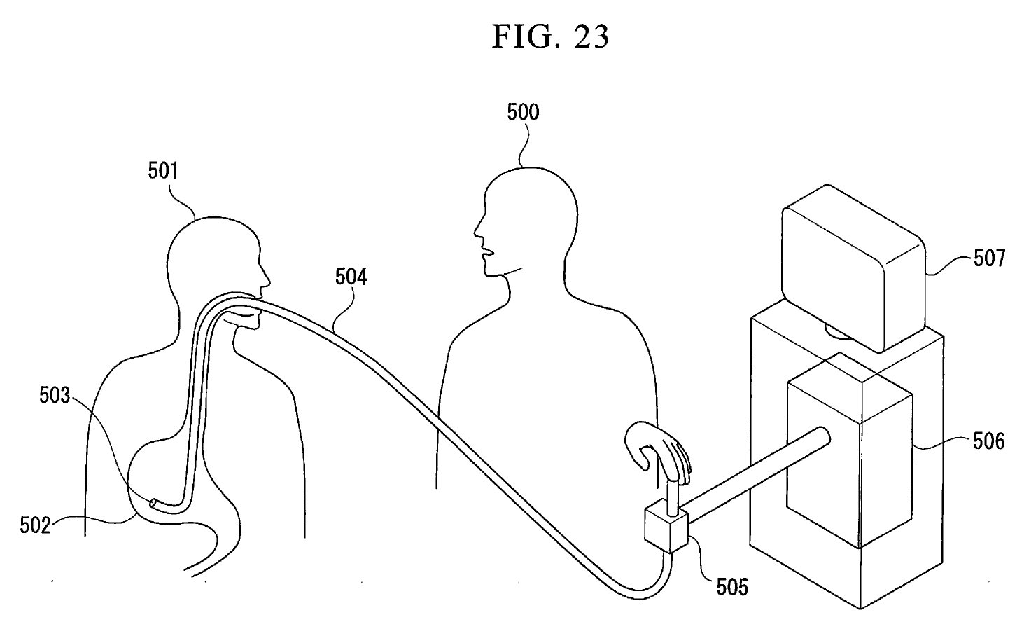

Hence, in order to display the image on the display portion 8, with respect to the image data output from the angle of view changing portion 104, the image size should be zoomed in/out by omitting or interpolating pixels. FIG. 22A-D show changing of the image size. In FIG. 22A-D, numbers shown on vertical and horizontal axes are respectively a vertical image size and a horizontal image size, and the image size of images FIG. A-D are respectively 1280×1024, 500×400, 352×288, and 352×288.

In FIG. 22A, the image is an image output from the angle of view output portion 104 when the object is not included in the object detection area, and the image of FIG. 22B is an image output from the angle of view output portion 104 when the object is included in the object detection area. When the display portion 8 of FIG. 2 displays in a size of image of CIF (352×288), a zoom-out operation is conducted by omitting with respect to the images of FIG. 22A and B, and the images of FIG. 22C and D are generated and output to the display portion 8. The media 9 or display portion 8 of FIG. 2 corresponds to the external apparatus which is the output destination of the digital camera 2.

As described above, in the digital camera 2 of this embodiment, with respect to the image data which is converted to the electrical signal from the optical image obtained via the lens 100 which has a large distortion in which the compression rate becomes larger along a direction of the center portion to the edge portion, the object detection portion 103 detects whether or not the object exists in the predetermined object detection area. In a case in which it is detected that the object is included in the object detection area, the angle of view changing portion 104 outputs the image data included in the object detection area, and in the case in which it is not detected, the angle of view changing portion 104 outputs the image data which is output from the imaging device 101. The image zoom-in/out portion 106 zooms in/out the image data output from the angle of view changing portion 104 in accordance with the image size required from an external apparatus to which the digital camera 2 outputs.

By applying such functions and operations, the angle of view output from the digital camera 2 is automatically changed in accordance with whether or not the object is included in the object detection area; therefore, it is possible to change the angle of view which includes the object in real time. Therefore, with respect to the image obtained via the optical system which has the distortion characteristic, it is possible to decide and adjust the zooming range accurately. Moreover, change of the angle of view is operated even when the user does not concern; therefore, it is possible to achieve usability improvement.

In this embodiment, an example is explained with respect to the case in which the center of the object detection area corresponds to the center of the optical image generated by the lens 100. In such a case in which the center of the object detection area corresponds to the optical axis of the optical system, it is possible to keep the degradation of the image quality to a minimum.

Hereinafter, a second embodiment of the present invention is explained. In this embodiment, an endoscope system which has the imaging apparatus of the present invention is explained as an example. FIG. 23 shows an image which is assumed in a case in which the endoscope system is used. In FIG. 23, in order to diagnose or cure viscera in a patient 501, a doctor 500 takes a photo of an inner wall 502 inside the body of the patient by using the endoscope system which includes: an imaging unit 503; a scope 504; an operation unit 505; a processor 506; and a monitor 507.

The imaging unit 503 is constituted from: a lens which forms an optical image; an image sensor which converts two-dimensionally received light to electrical signals; and a LED (Light-Emitting Diode) which irradiates upon taking photos. The scope 504 transmits the electrical signals. The operation unit 505 is provided in order to move the scope 504, operate treatment equipment provided at the top of the scope 504, or the like. The processor 506 conducts desired operations upon the electrical signals transmitted from the imaging unit 503. The monitor 507 displays the optical image received by the imaging unit 503.

In the endoscope system of this embodiment, when the LED of the imaging unit 503 irradiates; operations are conducted continuously such as the image sensor receives the optical image via the lens; and the optical image received by the image sensor is shown as an image on the monitor 507. The doctor 500 who uses the endoscope system, along with checking the image shown on the monitor 507, operates the operation unit 505 in order to move the scope 504, and can take a photo of the inner wall 502.

The processor 506, with respect to the electrical signals transmitted via the scope 504, conducts operations for higher image quality. The processor 506 has a recording medium (memory, storage, or the like) and records or stores the image transmitted from the imaging unit 503 if necessary. As described above, by referring to the image displayed on the monitor 507 or the image recorded or stored in the recording medium of the processor 506, diagnosis or treatment can be performed.

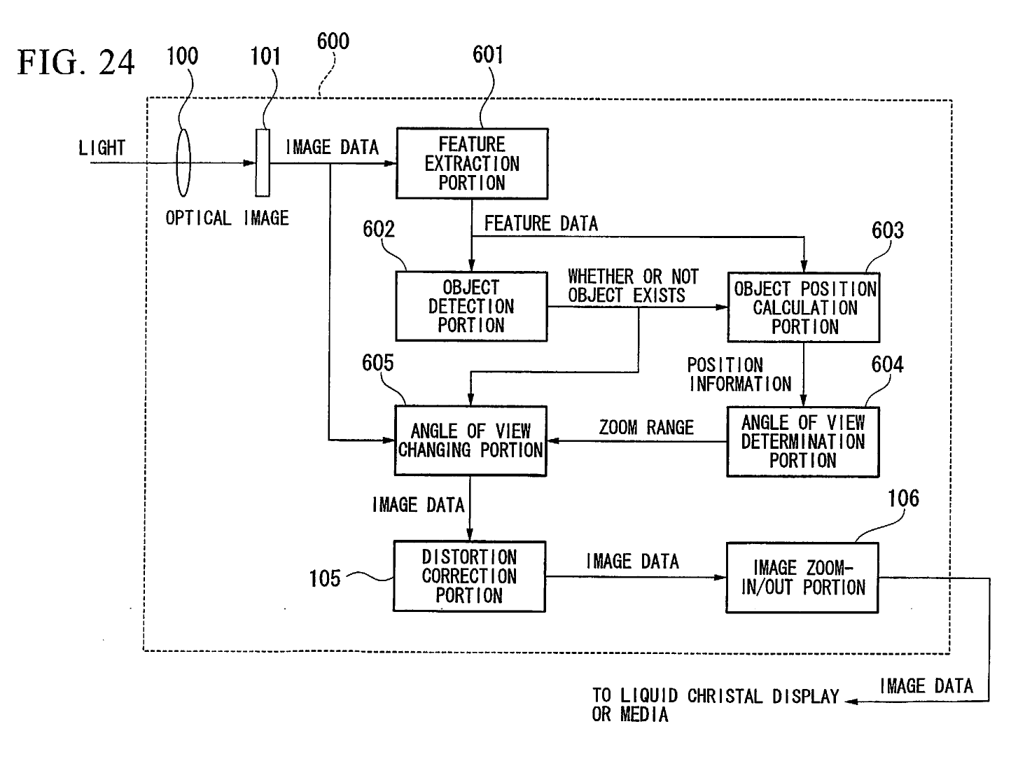

Hereinafter, a detailed constitution of the endoscope system is explained. FIG. 24 shows a constitution of characteristic portions of the endoscope system. With respect to the constitutional elements which have the same functions as in FIG. 3, explanations are omitted and the same reference numerals are assigned. Only portions that are different are explained. The endoscope system 600 of this embodiment is characterized by including: a feature extraction portion 601; an object detection portion 602; an object position calculation portion 603; an angle of view determination portion 604; and an angle of view changing portion 605. The lens 100 and the imaging device 101 of FIG. 24 are included in the imaging unit 503 of FIG. 23. The processor 506 includes: the feature extraction portion 601; the object detection portion 602; the object position calculation portion 603; the angle of view determination portion 604; the angle of view changing portion 605; the distortion correction portion 105; and the image zooming-in/out portion 106.

The feature extraction portion 601 extracts a feature from the image data from the imaging device 101. Hereinafter, in this embodiment, the feature is extracted by generating a brightness distribution, and by analyzing the brightness distribution, it is determined whether or not the object exists. As shown in FIG. 25, the feature extraction portion 601 has an image data correction portion 690 and a brightness distribution generation portion 700. The image data correction portion 690 corrects influences on images, which are caused by using the lens 100 which has distortion, such as optically caused distortions, increased light caused by compressing edges, or the like. The brightness distribution generation portion 700 (feature calculation portion) outputs the brightness distribution as the feature data which is output from the feature extraction portion 601.

The brightness distribution generation portion 700 converts the image data output from the image data correction portion 690 to a brightness signal, and generates the brightness distribution. Hereinafter, it is explained under the assumption that image data of R, G, and B with respect to one pixel is input to the brightness distribution generation portion 700. With respect to the image data of R, G and B used for generating one pixel, a value of the brightness of the pixel is calculated in accordance with a following formula (2).
Value of Brightness Y=0.299×R+0.587×G+0.114×B (2)

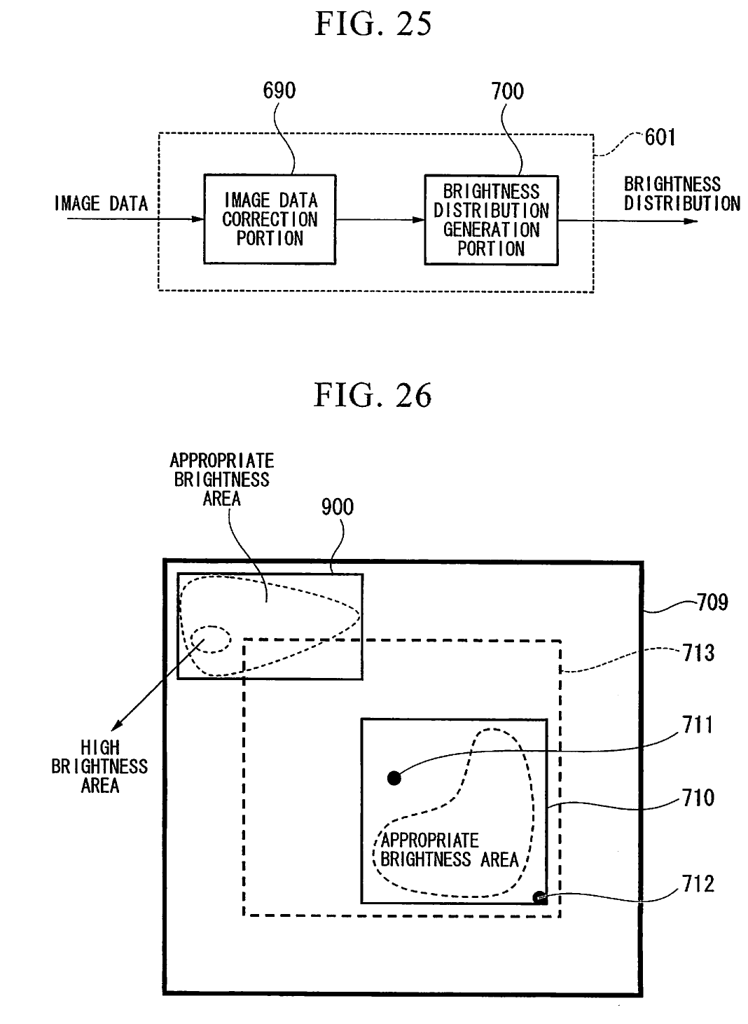

With respect to all pixels output from the imaging device 101 the brightness distribution is obtained by calculating in accordance with the formula (2). FIG. 26 shows an image of the brightness distribution obtained by calculating in accordance with the formula (2). An area 709 shown with a thick frame corresponds to the image of the brightness distribution.

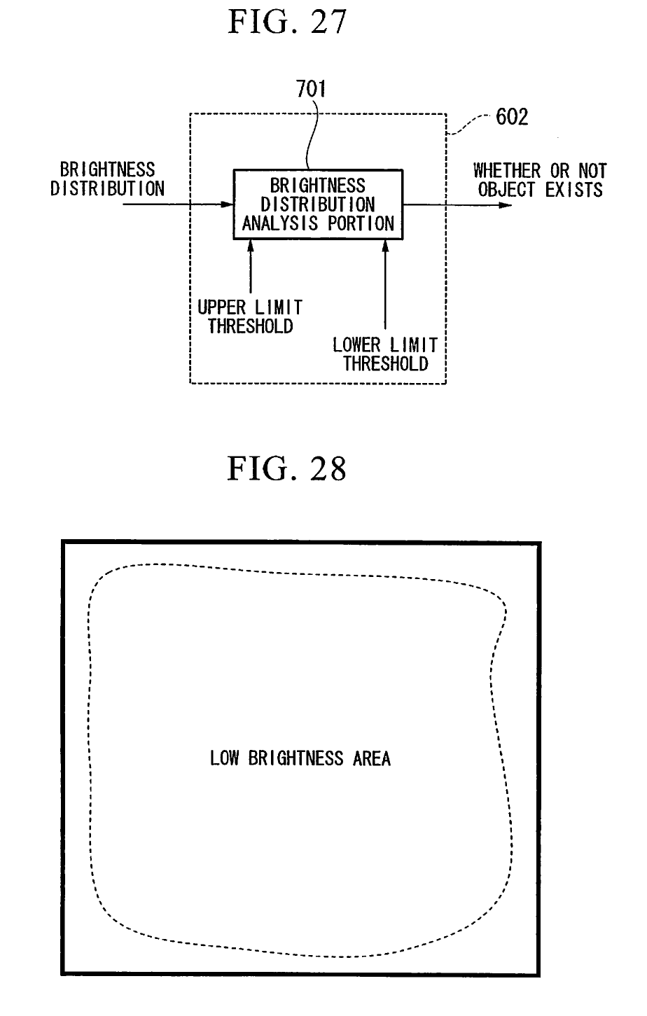

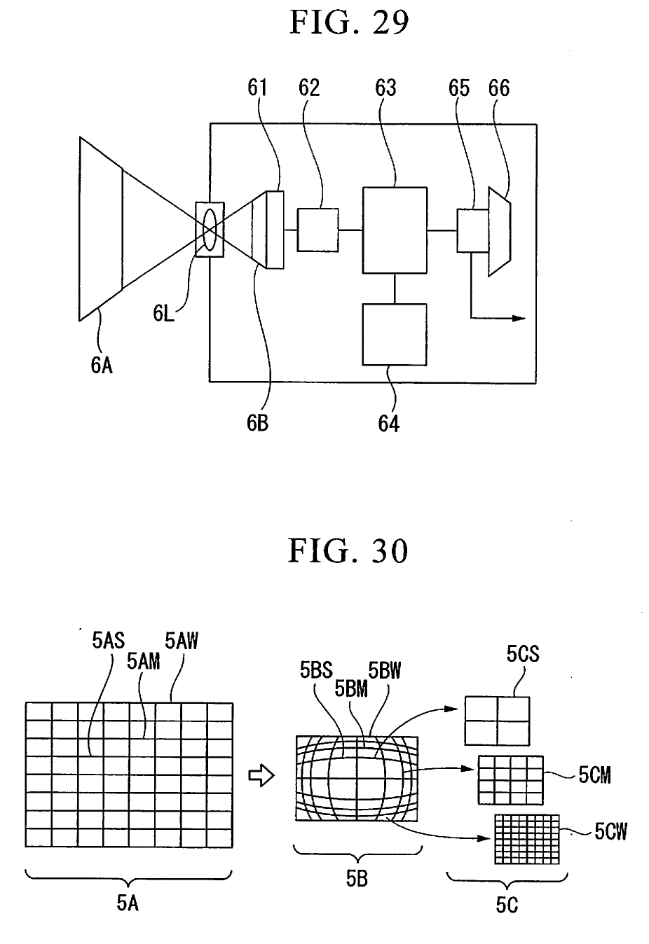

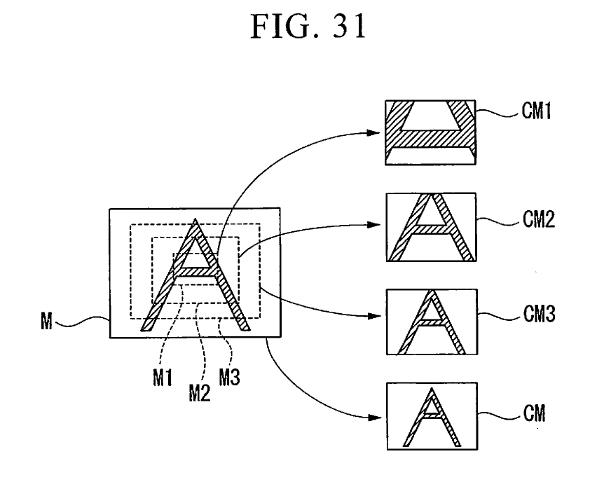

The object detection portion 602, by analyzing the feature data which is output from the feature extraction portion 601, detects whether or not the object is included in the image data which is output from the imaging device 101. As shown in FIG. 27, the object detection portion has a brightness distribution analysis portion 701 which detects a high brightness area, a low brightness area, and an appropriate brightness area among these areas by using an upper threshold and a lower threshold and comparing the brightness distribution, and which detects whether or not the object exists. The upper threshold and the lower threshold are determined in accordance with requirements of the user, conditions, or the like.

With respect to the image of the brightness distribution shown in FIG. 26, there is the appropriate brightness area in an area 710. This shows that enough light is obtained with respect to the object which is about to be photographed; and therefore, after taking photo with the endoscope system, it is possible to use the image of this area for diagnosis. Hence, with respect to the image data having the brightness distribution shown in FIG. 26, the brightness distribution analysis portion 701 determines that the object shown in the area 710 is included in the image data which is output from the imaging device 101.

In FIG. 26, the appropriate brightness exists in an area 900 as well. However, the area 900 includes a high brightness area. When the value of brightness is too high, the overall image is white; therefore, the image of the area 900 taken with the endoscope system cannot be used for diagnosis. Hence, the brightness distribution analysis portion 701 detects that the object is not included in the area 900.

On the other hand, with respect to the image having the brightness distribution shown in FIG. 28, the overall image is the low brightness area; therefore, the value of brightness of the overall image data is low. This shows that enough light is not obtained with respect to the object which is about to be photographed; and therefore, after photographing this image with the endoscope system, it is assumed to be difficult to use the image of this area for diagnosis. Hence, with respect to the image data having the brightness distribution shown in FIG. 28, the brightness distribution analysis portion 701 does not determine if the object shown in the area 710 is included in the image data which is output from the imaging device 101. As in the first embodiment there are various best detection conditions upon photographing with the endoscope system. Therefore, it is possible to implement by applying other methods described above.

When the object detection portion 602 detects that the object is included in the image data output from the imaging device 101, based on the feature data output from the feature extraction portion 601, the object position calculation portion 603 calculates a position which indicates where the object exists in the image and generates position information. Hereinafter, as described in the first embodiment, it is explained under the assumption that the center of the optical image generated by the lens 100 is in the same position as the center of the imaging device 101.

With respect to the image of the brightness distribution shown in FIG. 26, when the image size is horizontally 1280 and vertically 1024 and the left-upper point of the pixels is defined as the origin (1, 1), the center of the optical image, that is, the center 711 of the image data is expressed as the coordinate (640, 512). With respect to the area 710 which is determined as the object by the object detection portion 602, the object position calculation portion 603 outputs position data which is the coordinates of a point 712 that is positioned at a point that is farthest from the center 711 of the image data. When the center of the optical image and the center of the imaging device 101 are at different positions, the farthest coordinate from the center of the optical image, not from the center of the image data, is output.

The angle of view determination portion 604, based on the position information output from the object position calculation portion 603, determines the angle of view so as to include the object and set the center of the angle of view at the same position as the center of the optical image generated by the lens 100. With respect to the image of the brightness distribution shown in FIG. 26, when the coordinates of the point 712 which are output from the object position calculation portion 603 is (1039, 911), the angle of view determination portion 604 sets the center of the angle of view to the center 711 of the image data and determines the angle of view (zoom range) 713 shown as a broken line which passes coordinates (240, 112), (1040, 112), and (240, 912) so as to include the point 712.

The angle of view changing portion 605, based on the object detection result of the object detection portion 602, determines the output image data. In a case in which the object detection portion 602 detects that the object is included in the image data which is output from the imaging device 101, the angle of view changing portion 605 outputs the image data included in the zoom range determined by the angle of view determination portion 604, and in a case in which the object detection portion 602 does not detect that the object is included in the image data which is output from the imaging device 101, the angle of view changing portion 605 outputs the image data which is output from the imaging device 101.

In other words, when the angle of view based on the image data output from the imaging device 101 is defined as a first angle of view and the zoom range is defined as the range of the second angle of view which is smaller than the first angle of view, the angle of view changing portion 605 selects and outputs the image data corresponding to the second angle of view if the input signal from the object detection portion 602 indicates that the object exists. The angle of view changing portion 605 selects and outputs the image data which is output from the imaging device 101 and which corresponds to the first angle of view if the input signal from the object detection portion 602 does not indicate that the object exists. Based on the brightness distribution, it is detected whether or not the object is included in the object detection area; therefore, it is possible to set the angle of view so as to include the object which has a predetermined value of brightness. The image data output from the angle of view changing portion 605 is input to the distortion correction portion 105.

As described above, in the endoscope system 600 of this embodiment the object detection portion 602 detects whether or not the object exists with respect to the image data which is converted to the electrical signal from the image obtained via the lens 100 which has a large distortion in which the compression rate becomes larger along a direction from the center portion to the edge portion. When it is detected that the object is included in the image data output from the imaging data, the object position calculation portion 603 calculates the position information on the image of the object included in the image data. The angle of view determination portion 604, based on the position information, determines the angle of view (zoom range) so as to include the object and set the center of the angle of view to the same position as the center of the optical image generated by the lens 100.

In a case in which the object detection portion 602 detects that the object is included in the image data which is output from the imaging device 101, the angle of view changing portion 605 outputs the image data included in the zoom range determined by the angle of view determination portion 604, and in a case in which the object detection portion 602 does not detect that the object is included in the image data which is output from the imaging device 101, the angle of view changing portion 605 outputs the image data which is output from the imaging device 101. The image zoom-in/out portion 106 zooms in/out the image data output from the angle of view changing portion 605 in accordance with the image size required from an external apparatus to which the endoscope system 600 outputs. A recording medium (memory, storage or the like) provided inside the monitor 507 or the processor 506 in FIG. 23 corresponds to the external apparatus which is the output destination of the endoscope system 600.

In accordance with such constitutions or functions, the same effects can be obtained as in the first embodiment. Especially, by applying the endoscope system of this embodiment, based on the image which is obtained via the optical system which has a compression rate that becomes larger along a direction from the center portion to the edge portion, and in accordance with the information which indicates the position where the object exists, the image can be obtained as close to center of the optical image as possible. Therefore, it is possible to improve high image quality of the endoscope system 600.

Upon diagnosis along with reference to the image displayed on the monitor, the endoscope system automatically determines whether or not the image is appropriate for diagnosis without a request from a doctor to change the angle of view and displays the image on the monitor after zooming-in/out for appropriate diagnosis. Therefore, it is possible to improve the usability of the endoscope system.

In the first embodiment of the present invention, by detecting the motion vector, the feature extraction portion 102 and the object detection portion 103 conduct the extraction of the feature and detection of whether or not the object is included in the predetermined area. However, it should be noted that, by generating the brightness distribution based on the image data output from the imaging device 101, it is possible to conduct the extraction of the feature and detection of whether or not the object is included in the predetermined area. In this case, the feature extraction portion 102 and the object detection portion 103 of FIG. 3 are replaced by the feature extraction portion 601 and the object detection portion 602 respectively.

The feature extraction portion 601 generates the brightness distribution in accordance with the above method, based on the image data which is inside the predetermined area externally specified by the photographer and which is included in the image data output from the imaging device 101. In accordance with the above method, the object detection portion 602 analyzes the brightness distribution generated by the feature extraction portion 601 and detects whether or not the object is included in the predetermined area.

In accordance with the above methods and functions, it is detected whether or not the object is included in the predetermined area; therefore, it is possible to operate an object detection in the best manner especially when the object in a state of a estimated brightness to some degree, such as an actor/actress in a spotlight or the like, is photographed with the digital camera 2.

In the second embodiment of the present invention, the feature extraction portion 601, the object detection portion 601 and the object position calculation portion 603 operate the feature extraction, detection whether or not the object exists, and calculation of the object position by generating the brightness distribution. In this case, the feature extraction portion 601 and the object detection portion 602 of FIG. 24 are respectively replaced by the feature extraction portion 102 and the object detection portion 103 of FIG. 3.

The feature extraction portion 102 detects the above described motion vector based on the image data output from the imaging device 101. The object detection portion 103, in accordance with the above described method, analyzes the motion vector detected by the feature extraction portion 102 and detects whether or not the object is included in the image data output from the imaging device 101. When the object detection portion 103 detects that the object is included in the image data output from the imaging device 101, based on the motion vector output from the feature extraction portion 102, the object position calculation portion 603, in accordance with the above described method, calculates a position which indicates where the object exists on the image and generates position information.

In accordance with the above methods and functions, the object detection is operated based on the motion vector of the image data output from the imaging device 101; therefore, it is possible to operate the object detection in the best manner especially upon diagnosing a patient by photographing the object such as the bleeding inner wall 502 or the like with the endoscope system.

In accordance with the present invention, the angle of view is automatically adjusted based on whether or not the object exists in the first angle of view or the second angle of view, therefore, it is possible to adjust the angle of view which includes the object in real time, and therefore, there is an advantage by which it is possible to determine the zoom range quickly and appropriately for the image obtained via the optical system with the distortion characteristic.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims. Especially, with respect to the object detection method realized by applying the feature extraction portion and the object detection portion, it is possible to apply various well-known object detection methods. In the present invention, it is also possible to apply a constitution which includes multiple apparatuses for realizing such various detection methods and in which the object detection methods are switched in accordance with preference or the like.

What is claimed is:

1. An imaging apparatus comprising:
an optical system which has a distortion in which a compression rate becomes larger along a direction from a center portion to an edge portion;
an imaging device which converts an optical image received via the optical system to an electrical signal and outputs image data of a first angle of view;
a feature extraction portion that extracts a feature of data which corresponds to a second angle of view among the image data, which includes an optical axis of the optical system and which is smaller than the first angle of view, and outputs as feature data;
an object detection portion which outputs a signal which indicates whether or not the object is included in the second angle of view based on the feature data;
an angle of view changing portion which selects and outputs the image data corresponding to the second angle of view when the signal input from the object detection portion indicates that the object is included, and which selects and outputs the image data corresponding to the first angle of view when the signal input from the object detection portion does not indicate that the object is included;
a distortion correction portion which corrects a distortion in the image data output from the angle of view changing portion; and
an image zoom-in/out portion which zooms in/out the image data output from the distortion correction portion in accordance with a desired image size.

2. An imaging apparatus comprising:
an optical system which has a distortion characteristic in which a compression rate becomes larger along a direction from a center portion to an edge portion;
an imaging device which converts an optical image received via the optical system to an electrical signal and outputs image data of a first angle of view;
a feature extraction portion which extracts a feature of the image data and outputs as feature data;
an object detection portion which outputs a signal which indicates whether or not the object is included in the image data based on the feature data;
an object position calculation portion which calculates a position of the object in the image and generates position information when the signal input from the object detection portion indicates that the object is included;
an angle of view determination portion which, based on the position information, determines a size of a second angle of view of the image data in a manner in which the second angle of view includes an optical axis of the optical system and is smaller than the first angle of view;
an angle of view changing portion which selects and outputs the image data corresponding to the second angle of view when the signal input from the object detection portion indicates that the object is included, and which selects and outputs the image data corresponding to the first angle of view when the signal input from the object detection portion does not indicate that the object is included;
a distortion correction portion which corrects a distortion in the image data output from the angle of view changing portion; and
an image zoom-in/out portion which zooms in/out the image data output from the distortion correction portion in accordance with a desired image size.

3. The imaging apparatus according to claim 1, wherein the feature extraction portion comprises:
an image data correction portion which corrects errors caused by the distortion characteristic of the optical system; and
a feature calculation portion which calculates the feature data based on the image data corrected by the image data correction portion.

4. The imaging apparatus according to claim 1, wherein the feature extraction portion comprises:
an image data storing portion which stores the image data of a prior image; and
a motion vector detection portion which detects a motion vector based on both the image data stored in the image data storing portion and image data following the prior image data, and outputs the motion vector as feature data, wherein
the object detection portion comprises a vector analysis portion which, based on the motion vector, outputs a signal which indicates whether or not the object is included.

5. The imaging apparatus according to claim 4, wherein the vector analysis portion outputs a signal which indicates that the object is included when an absolute value of the motion vector which is output from the motion vector detection portion is smaller than a predetermined threshold.

6. The imaging apparatus according to claim 1, wherein the feature extraction portion comprises: a brightness distribution generation portion which generates a brightness distribution based on the image data and outputs as the feature data; and
the object detection portion comprises a brightness distribution analysis portion which, based on the brightness distribution, outputs a signal which indicates whether or not the object is included.

7. The imaging apparatus according to claim 1, wherein the feature extraction portion adjusts a center of the second angle of view in order to correspond with the optical axis of the optical system.

8. The imaging apparatus according to claim 2, wherein the angle of view determination portion adjusts a center of the second angle of view in order to correspond with the optical axis of the optical system.
